(19) United States
(12) Patent Application Publication
(10) Pub. No.: US 2005/0251438 A1
(43) Pub. Date: Nov. 10, 2005

(54) Methods and system for evaluation with notification means

(76) Inventors: Yi-Ming Tseng, Palo Alto, CA (US); Bin-Ming Benjamin Tsai, Saratoga, CA (US)

Correspondence Address: YI-MING TSENG, P.O. BOX 19428, STANFORD, CA, 94309-9428, US

(21) Appl. No.: 10/839,540

(22) Filed: May 4, 2004

(51) Int. Cl. G06F 17/60

(52) U.S. Cl. 705/10

(57) ABSTRACT

Methods and system of evaluation with notification options. The methods comprise (a) receiving evaluation input from at least one evaluator; (b) providing an option to send notification relating to said evaluation input; (c) generating at least one notification message if the notification is decided to be sent; and (d) sending the at least one notification message to at least one recipient if the at least one notification message has been generated. The system comprises an evaluation processing means, an evaluation database, evaluation input devices, and notification receiving devices. The system may further comprise a message server and a communications network. Illustrative examples include business, family, customer survey, and law enforcement applications.

### FIELD OF THE INVENTION

This invention relates to methods and system for evaluating behavior, performance, or results of performance or behavior, and more specifically, methods and system of evaluation with means for an evaluator to select, edit, and send notification messages to one or more relevant parties based on event-driven evaluation actions.

### BACKGROUND OF THE INVENTION

Evaluation usually exists, as long as there is a relation between two or more subjects. At work, superiors and subordinates evaluate each other, peers evaluate each other, suppliers and customers evaluate each other, employees and customers evaluate products and services, etc. At home, parents and children, spouses, partners, siblings, masters and pets, neighbors, etc. evaluate each other or conduct one-way evaluation. Evaluation also exists in other relations, e.g., teachers and students, users and products, police and people, friends, strangers, etc.

Evaluation can be periodic or event-driven. Periodic evaluation represents an evaluator's recollection and records of the overall performance of an evaluated object or its responsible party during a period, e.g., a quarter or in one year. Event-driven evaluation represents an evaluator's perception or judgment on the performance of an evaluated party when an event occurs, e.g., contribution of a brilliant idea in a meeting, use of a product, and being late for school. Event-driven evaluation should be incorporated into periodic evaluation. However, with existing methods, event-driven evaluation is sometimes not remembered or not recorded inadvertently.

Evaluation and subsequent notification, advice, and assistance often serve as means for improvement. At work, periodic evaluation is done on paper or Web forms, whereas event-driven evaluation could be in evaluators' minds or through questionnaires. Notification following periodic evaluation is sent through correspondence or email; event-driven notification is generally oral, or through email. At home, evaluation is usually event-driven, followed by oral, through notes, or email notification.

Timely notification based on event-driven evaluation can facilitate mindfulness and subsequent improvement of the evaluated object or its responsible party. Nevertheless, the existing notification methods based on oral communication, email, or notes have disadvantages. For example, it is not integrated with the periodical evaluation system in a structured way; it could significantly interrupt other tasks which are more important (e.g., a meeting); it could cause verbal conflict and therefore result in waste of time and deterioration of relationship. In order to mitigate those disadvantages, this invention provides methods of evaluation with options to select, edit, and send timely notification messages based on event-driven evaluation to one or more recipients and is integrated with the overall evaluation system. Such invention is not found in the relevant prior art, which is reviewed as follows.

Some prior art inventions disclose methods of performance evaluation and behavior control. Cobb, et al. in U.S. Patent Application publication No. 2004/0016437 disclose a method for delivering behavior information over a network comprising: (a) monitoring an action of a user on the network to obtain observed user data; (b) obtaining user supplied data relating to the desired behavior modification; (c) evaluating the observed user data and user supplied data to generate tailored information for progressing a user towards the desired behavior modification; (d) presenting the tailored information to the user over the network; and (e) repeating (a), (b), (c), and (d) until the desired behavior modification is achieved.

Smith in U.S. Pat. No. 6,618,723 discloses an interpersonal development communications system and directory that determines a participant's motivators in view of a requester's motivators and values and automatically provides recommended guidance for the requester to manage and communicate effectively with participants who are subordinates, peers, and superiors in an organization.

Powers et al. in U.S. Pat. No. 6,604,084 disclose a performance evaluation system based on a plurality of questions and performance areas.

Some prior art inventions disclose performance evaluation, recording, and reporting methods which address specific application areas, e.g., healthcare, sports, safe driving, and finance. Glover in U.S. Pat. No. 6,711,547 discloses a handheld medical processing device storing patient records, prescriptions, and x-rays used by physicians. Burrild, et al. in US. Patent Application publication No. 2003/0171952 disclose a system and method for assessing quality of life and its development. Teller, et al. in U.S. Pat. No. 6,605,038 disclose a system for detecting, monitoring, and reporting physiological information with sensors. Rohler, et al. in U.S. Pat. No. 6,292,783 disclose a document information system and a computer implemented method for use in the field of home healthcare, post-acute clinical care, and hospice and home infusion comprising a data storage means, phone interface for inputting and retrieving data, and a verification means using one or more calendars to verify medical tasks.

Miller in U.S. Pat. No. 5,681,108 discloses a handheld data processing system stores and retrieve golf information and operates as a golf scorekeeper using a voice recognition system. The golf scorekeeping system is capable of inputting, outputting, and storing data using a combination of manual, visual, and audio elements. Wilens in U.S. Pat. No. 5,779,566 discloses a handheld computerized golf data recording, reporting, and advising unit, and a method of its operation. Tobey, et al. in U.S. Pat. No. 6,714,894 disclose a system and methods for the collection, processing, and distribution of information to promote driver safety, by inputting accident and traffic infraction events. Suer, et al. in U.S. Pat. No. 6,431,439 disclose an information storage and transmission device which captures financial transaction data, stores the information, and then wtirelessly transmits the information to different terminal units.

The prior art disclose some methods for evaluation, recording, reporting, and improvement of performance or behavior; however, they have several disadvantages. Although some of the prior inventions provide reports based on summary and analysis of a collection of events, none of them has addressed event-driven notification to the responsible party of the evaluated object and subsequent response and communication. They do not provide an option for the responsible party of the evaluated object to keep a separate event-driven self-evaluation records. Furthermore, the application areas of prior inventions are limited.

Accordingly, objects and advantages of the present inventions may comprise at least one of the following:
(a) to provide evaluation methods and system with an option of timely notifying the responsible party of an evaluated object (or for short, the evaluated party), for faults or merits, and therefore mindfulness, motivation, and improved performance of the evaluated party;
(b) to provide evaluation methods and system which incorporate event-driven evaluation and self-evaluation records into the periodic evaluation and overall evaluation in a systematic way;
(c) to provide evaluation methods and system which incorporate event-driven evaluation and self-evaluation records into the periodic evaluation and overall evaluation in a convenient way;
(d) to provide event-driven evaluation methods and system which reduce task interruption, verbal conflicts, and relationship disruption caused by unstructured notification of evaluation action (e.g., in the form of complaints, nagging, or scolding based on negative evaluation);
(e) to provide evaluation methods and system with an option of timely notifying relevant parties of evaluation and self-evaluation action, for review and therefore improved fairness of the evaluation;
(f) to provide evaluation methods and system which can be widely applied in various relations, e.g., organizations, families, customer relationship, law enforcement, and self-improvement; and
(g) to provide evaluation methods and system which save transactional costs and paper usage.

### SUMMARY

Some aspects of the invention relate to a method of evaluation with means for notifying at least one recipient comprising: receiving evaluation input from at least one evaluator, the evaluation input being based on the perception of at least one event relating to at least one evaluated object by the at least one evaluator; providing means for sending notification relating to the evaluation input; generating at least one notification message; and sending the at least one notification message to the at least one recipient.

In a further embodiment, the notification message is sent to a notification receiving device, the notification receiving device being selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

In a further embodiment, the method of evaluation is used in organization member evaluation, in family member evaluation, in law enforcement, and in evaluation of any of service, service provider, process, process provider, product, and product provider.

In a further embodiment, the evaluation input is recorded in an evaluation database, which contains information of the at least one evaluated object.

In a further embodiment, the at least one evaluator is selected from a group consisting of human beings, computers, machines, virtual machines, robots, sensing devices, and animals.

In a further embodiment, the at least one notification message comprises a consolidation of the evaluation input from multiple evaluators, or a consolidation of the evaluation input relating to multiple events.

In a further embodiment, the sending step is carried out through a communications network, the communications network comprising any of an Internet, a wireless Internet, a mobile Internet, an intranet, a wireless intranet, a mobile intranet, an extranet, a mobile extranet, a fixed-line WAN, a wireless WAN, a mobile WAN, a fixed-line LAN, a wireless LAN, a mobile WAN, a fixed-line PAN, a wireless PAN, a mobile PAN, a fixed-line communication network, a mobile communication network, a trunk radio network, a paging network, and a radio network.

In a further embodiment, content of the at least one notification message comprises any of a text, a voice, an image, a video, a smell, a taste, and a feel format.

In a further embodiment, the at least one notification message contains a proof of authenticity.

In a further embodiment, the method further comprises a step of providing privilege control of evaluation or of notification.

In a further embodiment, the evaluation input is received from an evaluation input device, the evaluation input device being selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot. In one embodiment, the method further comprises a step for processing the evaluation input, wherein the processing step is performed on the evaluation input device.

In a further embodiment, the method of evaluation with means for notifying at least one recipient further comprises a step for processing the evaluation input based on at least one set of evaluation criteria. In one embodiment, the processing step is carried out by an evaluation server means for processing the evaluation input.

In a further embodiment, the method of evaluation with means for notifying at least one recipient further comprises a notification deciding step, wherein the decision is selected from a group consisting of when, whom, where, and how to send the notification, and what to be included in the notification. In one embodiment, the notification deciding step is carried out by the at least one evaluator. In another embodiment, the notification deciding step is carried out based on at least one set of rules, wherein the at least one set of rules comprises a factor that is selected from a group consisting of at least one characteristic of the evaluator, the evaluation input, result of the processing step, at least one characteristic of the evaluated object, delay, time, recipient, address, phone number, default message, and message content for the notification.

In a further embodiment, the method of evaluation with means for notifying at least one recipient further comprises a step of requesting for evaluation input from the at least one evaluator. In one embodiment, the requesting step is carried out based on at least one characteristic of any of the event and the evaluated object, wherein the at least one characteristic is selected from a group consisting of time, duration, distance, location, use, frequency, expense, value, and demographics.

In a further embodiment, the method of evaluation with means for notifying at least one recipient further comprises a response deciding step to be carried out by the at least one recipient, for at least one decision of whether to send a response to the notification. In one embodiment, the method further comprises at least a second response decision, wherein the at least a second response decision is selected from a group consisting of when, whom, where, and how to send the response, and what to be included in the response. In another embodiment, the response deciding step is granted by the evaluator or granted based on at least one set of rules.

In a further embodiment, the method of evaluation with means for notifying at least one recipient further comprises a step of searching and selecting the at least one evaluated object by the at least one evaluator. In one embodiment, the method further comprises a step of providing privilege control on the step of searching and selecting.

Some aspects of the invention relate to a method of evaluation with means for notifying at least one recipient comprising steps of: receiving evaluation input from at least one evaluator, the evaluation input being based on the perception of at least one event relating to at least one evaluated object by the at least one evaluator; and deciding whether to generate at least one notification message based on the evaluation input in step (a). In one embodiment, the deciding step is carried out by the at least one evaluator or carried out based on at least one set of rules.

Some aspects of the invention relate to a system of evaluation of at least one evaluated object comprising: an evaluation means for processing evaluation input and transmitting at least one notification message, wherein the evaluation means contains at least one set of evaluation criteria; an evaluation database comprising information of the at least one evaluated object, wherein the database is accessible by the evaluation means; at least one evaluation input device that receives the evaluation input and transmits the input to the evaluation means; and at least one notification receiving device that receives the at least one notification message from the evaluation means.

In the evaluation database, the information of the at least one evaluated object may include consolidated and respective evaluation results by at least one evaluator. A responsible party of the at least one evaluated object may also be an evaluator, and self-evaluation results can also be retrieved separately from the database.

In a further embodiment, the evaluation database further comprises information of at least one evaluator.

In a further embodiment, the at least one evaluation input device is selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

In a further embodiment, the at least one notification receiving device is selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

In a further embodiment, the evaluation means is comprised in the evaluation input device.

In a further embodiment, the system of evaluation of at least one evaluated object further comprises at least one Web server.

In a further embodiment, the system of evaluation of at least one evaluated object further comprises at least one firewall.

In a further embodiment, the system of evaluation of at least one evaluated object further comprises a message server means for storing and transmitting messages.

In a further embodiment, the system of evaluation of at least one evaluated object further comprises at least one communication network connecting the at least one evaluation input device and the at least one notification receiving device to any of the evaluation means and server means, wherein the at least one communications network comprises any of an Internet, a wireless Internet, a mobile Internet, an intranet, a wireless intranet, a mobile intranet, an extranet, a mobile extranet, a fixed-line WAN, a wireless WAN, a mobile WAN, a fixed-line LAN, a wireless LAN, a mobile WAN, a fixed-line PAN, a wireless PAN, a mobile PAN, a fixed-line communication network, a mobile communication network, a trunk radio network, a paging network, and a radio network.

### BRIEF DESCRIPTION OF THE DRAWINGS

Brief description of the drawings is listed below. Additional objects and features of the present invention will become more apparent, and the invention itself will be best understood from the following Detailed Description of Exemplary Embodiments, when read with reference to the accompanying drawings.

FIG. 1 is a flowchart of a method for evaluation with notification means.

FIG. 2 is a flowchart of a business application example of a method for evaluation with notification means.

FIG. 3 is a flowchart of a family application example of a method for evaluation with notification means.

FIG. 4 is a flowchart of a customer survey application example of a method for evaluation with notification means.

FIG. 5 is a flowchart of a law enforcement application example of a method for evaluation with notification means.

FIG. 6 is one embodiment of the system for evaluation with notification means.

### DETAILED DESCRIPTION OF EXEMPLARY EMBODIMENTS

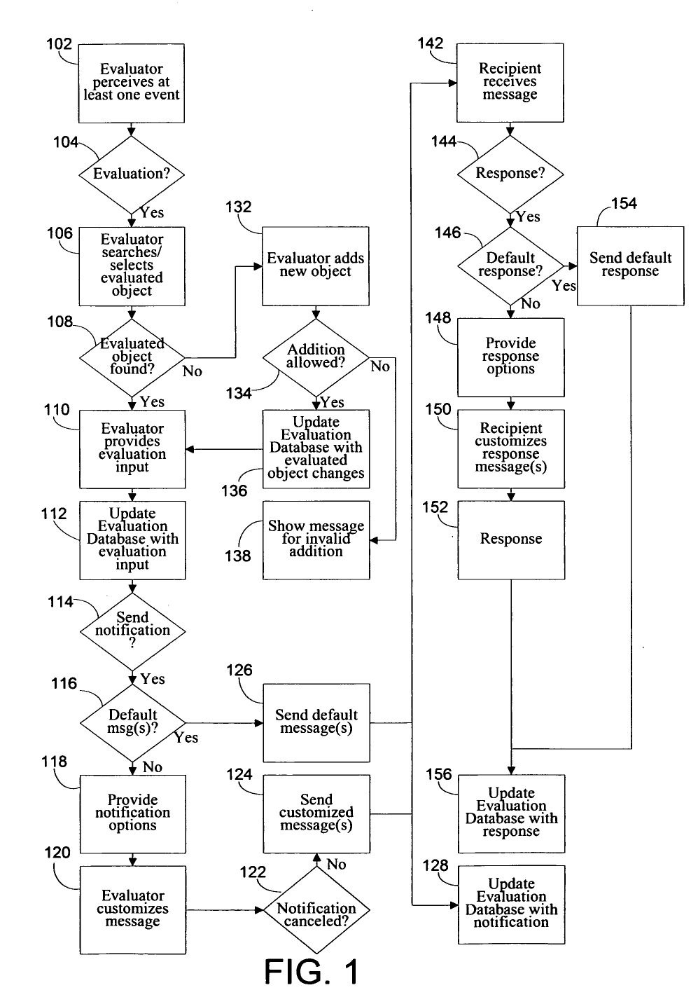

Referring to FIGS. 1 to 6, what is shown is an embodiment of methods and system for evaluation with notification means or options according to the principles of the invention. While the description set forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described below. The present invention relates to evaluation methods and system which provide means for an evaluator, self-evaluator, or evaluation server to select, edit, and send timely notification messages to one or more relevant recipients.

A generic exemplary embodiment of the methods comprises one or more of the following steps: (a) receiving evaluation input from at least one evaluator, the evaluation input being based on the perception of at least one event relating to at least one evaluated object by the at least one evaluator; (b) providing means for sending notification relating to the evaluation input; (c) generating at least one notification message; and (d) sending the at least one notification message to at least one recipient. In one embodiment, the at least one recipient may be the evaluated object, his/hers/its guardian, or his/hers/its supervisor.

A generic embodiment of the system comprises one or more of the following components: (a) an evaluation means comprising at least one processing unit and at least one memory unit containing at least one set of evaluation criteria; (b) an evaluation database accessible by the evaluation means containing information of at least one evaluated object; (c) message server means for storing and transmitting messages; (d) at least one evaluation input device; (e) at least one notification receiving device; and (f) at least one communications network connecting the at least one evaluation input device and the at least one notification receiving device to at least one of the servers. In one preferred embodiment, the evaluated object may comprise the evaluated party or parties.

Some other embodiments of the methods and system are for business applications. In one embodiment, upon the occurrence of an event, a manager using a cell phone or an evaluation server (with the form of a management system) can efficiently evaluate the performance of a subordinate and generate a timely notification to the subordinate and other relevant parties, with advice or comments, for timely correction or recognition, or to trigger a discussion, etc. The methods and system facilitate timely evaluation and notification. Rather than just trying to recall what has happened in a past quarter or past year, at the time of evaluation, the manager has sufficient input or evaluation data as an event occurs. Therefore, employee evaluation will be based on records and the evaluation is fair to the employee and his supervisor. Furthermore, timely notification will help employees follow standard operating procedures and improve performance and motivation.

Some other embodiments of the methods and system are family applications. In one embodiment, upon the occurrence of an event, a parent using a cell phone or an evaluation server (with the form of a family management system) can effectively evaluate the performance of a child and generate a timely notification to the child regarding the adjustment of monthly allowance as a result of the child's performance. The methods and system facilitate discipline of family members, while reducing verbal conflicts that resulted from nagging, complaints, etc. They also facilitate timely rewards, compliments, encouragement, etc., when the evaluated family member is not present as a relevant event is perceived. In another embodiment, when a parent comes home and sees the lawn has been mowed by a child as promised, but the child is out, the parent can immediately use her or his cell phone to credit the child's performance and send a notification.

Some other embodiments of the methods and system are for customer relationship management. In one embodiment, a restaurant may send a survey form, with an incentive to submit the form, to a customer's cell phone after the customer has been in the restaurant for thirty minutes. At her or his convenience, the customer can fill out the form and submit it with a few pushes of buttons on her or his cell phone, and then receive a coupon for next visit. If the customer's input is extraordinary or indicates an urgent matter, an evaluation server (with the form of a restaurant management system) will send the restaurant manager a message for immediate attention. At the end of a business day, the evaluation server will send each of the employees, including the manager, attendants, cooks, and janitors, a message containing customer survey information and advice relating to her or him. The methods and system provide a convenient and economical way for customers to offer their comments, for managers to take care of customer relationship in a timely fashion, and for all employees to know where and how to improve their performance.

Some other embodiments of the methods and system are for law enforcement applications. In one embodiment, when a police officer sees a car of parking violation, the officer can send a parking ticket to the car owner's cell phone. The car owner can receive the ticket immediately and pay the fine or choose other options on her or his cell phone at her or his convenience. The methods and system provide convenience for police officers and car owners, reduce administration, and reduce the use of paper.

FIG. 1 shows the steps in an embodiment of a method of evaluation with notification means in generic use.

The process starts with step 102, in which an evaluator perceives at least one event. The evaluator may be a human being, a computer, a computer application, a machine, a virtual machine, a robot, a sensing device, an animal, or something with perception capability.

Step 102 triggers step 104, in which the evaluator decides whether to conduct evaluation based on the at least one event. If the decision is “no”, then no further action will be taken. If the decision is “yes”, then in step 106, on or through her or his evaluation input device, the evaluator searches for or selects the relevant evaluated object. In one preferred embodiment, the evaluated object may comprise the evaluated party or parties.

Examples of evaluation input devices include computers, fixed-line phones, mobile phones, cellular phones, cordless phones, smart phones, personal digital assistants, Internet clients, remote controls, handheld devices, professional devices, watches, personal accessories, radio terminals, pagers, robots, and the like.

Step 108 provides conditions of whether the evaluated object is found or not.

If the evaluated object is not found, then in step 132 the evaluator adds the evaluated object as a new one using her or his evaluation input device.

In step 134 the evaluator server determines whether the evaluator's addition or evaluation of the evaluated object is allowed. This is an example of privilege and access control of the evaluation database, which contains information of evaluators and evaluated objects. The evaluator server comprises at least one processing unit and at least one memory unit containing at least one set of evaluation criteria, and it can access the evaluation database.

If in step 134 the addition is not allowed, in step 138 a message is sent to the evaluator's evaluation input device saying the addition is invalid. If the addition is allowed, then in step 136 the evaluation database is updated with the addition by the evaluator and associated changes in the information of the added evaluated object.

Given that the evaluated object is available for evaluation to the evaluator, in step 110 the evaluator provides evaluation input. The evaluator can input evaluation by selecting appropriate items from menus and input additional information using a keypad, voice, hand writing, etc.

Following step 110, in step 112 the evaluation database is updated with the evaluator's input.

Then in step 114 the evaluator decides whether to send notification regarding her or his evaluation input. The decision can also be automated in the evaluation server, based on at least one preset rules.

If notification is to be sent, in step 116 the evaluator decides whether to send one or more default messages. If the decision is “yes”, then in step 126 one or more default messages are sent to one or more default recipients.

If the decision is “no”, then in step 118 the evaluation server provides notification means or options. The means are related to when, whom, where, and how to send the notification, and what to be included in the notification. The content of a notification message may comprise any of the following formats: text, voice, image, video, smell, taste, and feel. The evaluator can also turn on direct communication with relevant parties. There can be control of the availability of the notification means as well.

Following step 118, the evaluation server (based on preset rules) or the evaluator edits the message and/or change notification settings, e.g., recipients, delivery time, etc.

Step 122 provides an option or means for the customized notification to be canceled if it has not been sent.

If the notification is not canceled, in step 124 the customized messages are sent according to the settings in step 118.

The notification message is sent through a communications network, which comprises any of the Internet, the wireless Internet, the mobile Internet, an intranet, a wireless intranet, a mobile intranet, an extranet, a mobile extranet, a fixed-line WAN, a wireless WAN, a mobile WAN, a fixed-line LAN, a wireless LAN, a mobile WAN, a fixed-line PAN, a wireless PAN, a mobile PAN, a fixed-line communication network, a mobile communication network, a trunk radio network, a paging network, a radio network, and the like.

Given step 126 or step 124, the evaluation database is updated with the notification.

Step 142 uses one recipient as an example, though there can be multiple recipients. In step 142 a recipient receives the notification message sent in step 126 or step 124 using her or his message receiving and displaying device. The evaluated party generally is a recipient of the notification.

Examples of message receiving and displaying devices may comprise computers, fixed-line phones, mobile phones, cellular phones, cordless phones, smart phones, personal digital assistants, Internet clients, remote controls, handheld devices, professional devices, watches, personal accessories, radio terminals, pagers, robots, and the like.

In step 144 the recipient decides whether to respond to the notification message. If the recipient decides to send default response, then in 154 one or more default response messages are sent to one or more response recipients, generally including the originator of the notification.

If the recipient decides to send customized response, then in step 148 means or options are provided. The means is related to when, whom, where, and how to send the notification, and what to be included in the notification. The content of a response message may comprise any of the following formats: text, voice, image, video, smell, taste, and feel. The recipient may also turn on direct communication with one or more parties. Again, there can be control of availability of the response means.

The provision of means or options for the recipient to respond to the notification can be determined by the evaluator or the evaluation server based on preset rules.

Following step 148, in step 150 the recipient edits one or more response messages and/or change response settings. In step 152, the response is sent and/or direct communication is set up.

Given step 154 or step 152, in step 156 the evaluation database is updated with the response. Some aspects of the invention relate to a method of evaluation with means for notifying at least one recipient comprising: receiving evaluation input from at least one evaluator, the evaluation input being based on the perception of at least one event relating to at least one evaluated object by the at least one evaluator; providing means for sending notification relating to the evaluation input; generating at least one notification message; and sending the at least one notification message to the at least one recipient.

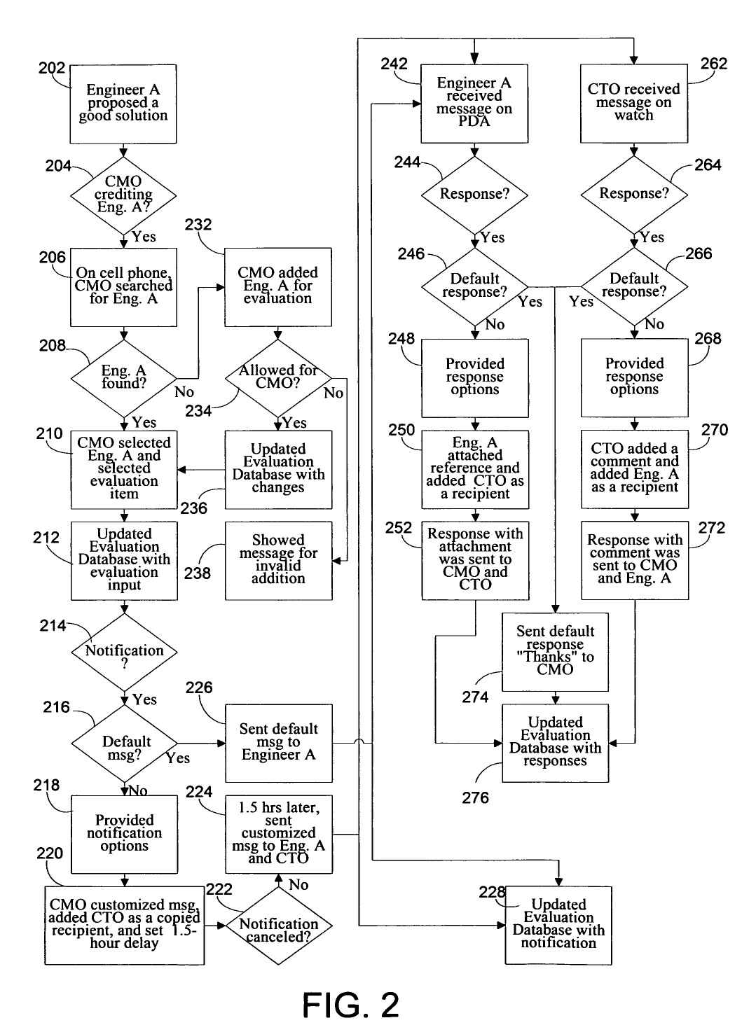

The method can have various applications. It is possible that the evaluated object is the evaluated party. It is also possible that the evaluator is the evaluated party, i.e., self-evaluation is possible. A business application example is provided in FIG. 2.

FIG. 2 illustrates an example of the steps in an embodiment of business applications.

In step 202, Engineer A in a meeting proposed a good solution to a critical problem.

In step 204 Chief Marketing Officer (CMO) considered whether to credit Engineer A.

Since CMO decides to credit Engineer A, in step 206 on her/his cell phone, CMO selected the evaluation menu and searched for Engineer A.

Step 208 provides conditions of whether Engineer A was found.

If Engineer A was not found, then in step 232 CMO tried to add Engineer A for evaluation. In step 234, the employee evaluation server decides if the addition was allowed. If it was not allowed, in step 238 the server sent a message to CMO which shows on her or his cell phone saying addition is invalid. If the addition is allowed, then in step 236 the employee evaluation database is updated with the addition and associated changes.

Given that the evaluation of Engineer A is available to CMO, in step 210 on her or his cell phone CMO selected Engineer A and selected evaluation item “Help solve a critical problem”, then submitted the evaluation.

Following step 210, in step 212 the employee evaluation database was updated with CMO's input.

In step 214 CMO's cell phone then prompted the decision of whether to send notification.

If CMO chose to send notification, then in step 216 her or his cell phone prompted the option of whether to send the default message.

If CMO chose to send the default message, in step 226 the message “Credited for helping solve a critical problem” was sent to Engineer A.

If CMO chose to send customized messages, in step 218 the employee evaluation server provided notification means which are available to CMO.

Then in step 220 CMO might attach an image relating to the solution to the default message, added Chief Technology Officer (CTO) as a copied recipient, and set the message to be sent 1.5 hours later, after the meeting.

In step 222 CMO had a chance to cancel the notification. If the notification was not canceled, in step 224 the customized message was sent to Engineer A and CTO about 1.5 hours later.

In step 228 the employee evaluation database was updated with CMO's notification.

In step 242 Engineer A received the default message from step 226 or the customized message from step 224 on her or his PDA.

In step 244, Engineer A's PDA prompted a decision of whether to respond to CMO's notification.

If Engineer A chose to respond, in step 246 her or his PDA then prompted whether to send the default response.

If Engineer A chose to send the default response, then in step 274 a message of “Thanks” is sent from Engineer A to CMO.

If Engineer A chose to send customized response, in step 248 the employee evaluation server provided response options which are available to Engineer A.

Then in step 250 Engineer A might attach a reference file and add CTO as a copied recipient.

In step 252 Engineer A's customized response with attachment was sent to CMO and CTO.

In step 262 CTO received CMO's customized message from step 224 on her or his watch.

In step 264 CTO's watch prompted whether to respond to CMO's message.

If CTO chose to respond, in step 266 CTO's watch prompted whether to send the default response message.

If CTO chose to send the default message, in step 274 a message of “Thanks” is sent from CTO to CMO.

If CTO chose to send customized messages, in step 268 the employee evaluation server provided CTO response options which are available to CTO.

Then in step 270 CTO might add a comment on the solution and added Engineer A as a copied recipient.

In step 272 CTO's response with a comment was sent to CMO and Engineer A.

In step 276 the employee evaluation database was updated with Engineer A's response and CTO's response.

In the example, CMO credited Engineer A without interruption of and distraction from the ongoing meeting. Engineer A's performance was credited without being forgotten by CMO after the meeting. Additional information and comments were exchanged through notification and response.

Some aspects of the invention relate to a method of evaluation with means for notifying at least one recipient comprising steps of: receiving evaluation input from at least one evaluator, the evaluation input being based on the perception of at least one event relating to at least one evaluated object by the at least one evaluator; and deciding whether to generate at least one notification message based on the evaluation input in step (a). In one embodiment, the deciding step is carried out by the at least one evaluator or carried out based on at least one set of rules.

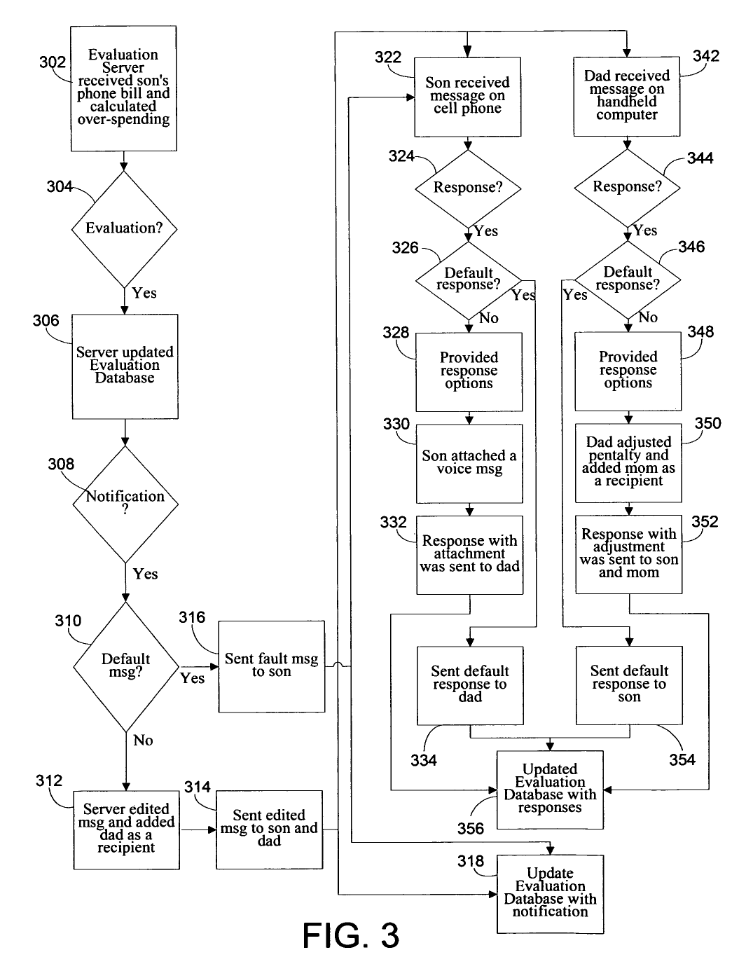

FIG. 3 illustrates an example of the steps in an embodiment of family applications. In the example the evaluator in the illustrated event was a computer.

In step 302 the family evaluation server received the teenager son's phone bill of June and calculated that the billed amount exceeded the son's monthly call allowance by $22.

In step 304 the family evaluation server decided whether to perform evaluation based on a set of rules, e.g., “perform evaluation if the over-called amounts exceeded $15 for two consecutive months.”

If the family evaluation server decides to perform evaluation, then in step 306 the server updated family evaluation data base.

In step 308 based on preset rules, the family evaluation server decided whether to provide notification.

If the family evaluation server decided to provide notification, in step 310 the server decided whether to send the default message.

If the family evaluation server decided to send the default message, in step 316 the server might send to the son a message of “Phone bill: $62; $22 over-spent; July allowance deduction: $33.”

If the family evaluation server decided to sent customized messages, in step 312 the server might add the 5 most called numbers on the bill to the message and add the dad as a recipient. Then in step 314 the customized message was sent to the son and the dad.

In step 318 the family evaluation database was updated with the family evaluation server's notification.

In step 322 the son received the family evaluation server's message on his cell phone.

In step 324 the son's cell phone prompted “Response?” If the son chose to respond, then in step 326 his cell phone prompted “Default response?”

If the son chose default response, then in step 334 a message example of “Sorry” was sent from the son to the dad.

If the son chose customized response, in step 328 the family evaluation server provided response options which are available to him.

In step 330, the son might attach a voice message explaining reasons for over spending on the phone. Then in step 332 the son's response with attachment was sent to dad.

In step 342 the dad received the message from the family evaluation server on his handheld device.

In step 344 the dad's handheld prompted “Response?” If the dad chose to respond, in step 346 his handheld prompted “Default response?”

If the dad chose default response, in step 354 a message example of “Be careful next month” was sent from the dad to the son.

If the dad chose customized response, in step 348 the family evaluation server provided response options which are available to him.

In step 350 the dad might adjust the penalty or monthly allowance deduction from $33 to $22 and add the mom as a recipient. Then in step 352 the dad's response with adjustment was sent to the son and the mom.

In step 356 the family evaluation database was updated with the son's response and the dad's response.

In this example, the son was disciplined for over spending, and there was no nagging or verbal conflict. Family rules were executed automatically, and adjustment with human consideration was done in a convenient way.

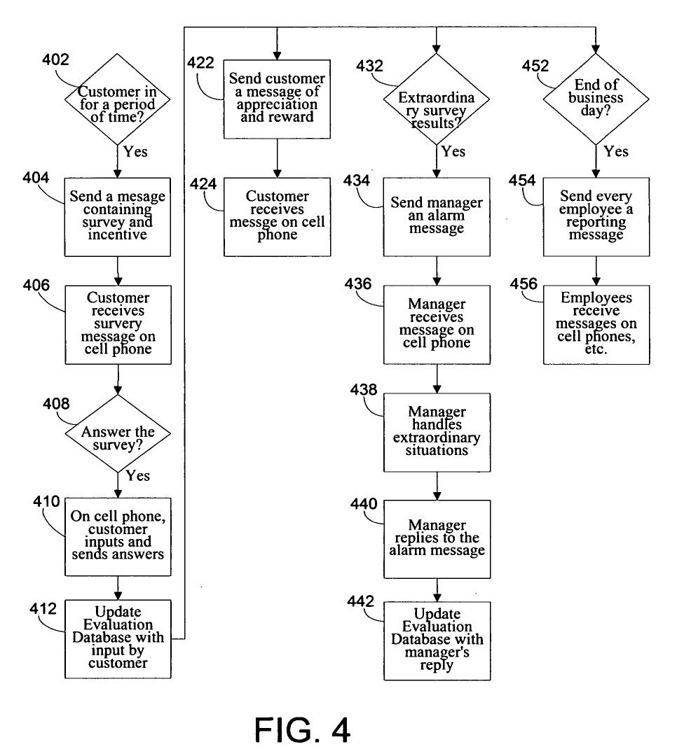

FIG. 4 illustrates an example of the steps in an embodiment of customer survey and service applications. In the example the evaluator was requested to perform evaluation, and notification could be a consolidation of evaluation based on multiple events performed by multiple evaluators.

Step 402 is an example of criteria for sending request for evaluation. In step 402 whether a customer has been in a restaurant for 30 minutes is determined by, for example, the time when the customer's cell phone enters the coverage of the small radio station which covers the restaurant. In this case, the customer needs to have agreed to such monitoring for privacy consideration.

If the customer has been in the restaurant for 30 minutes, then in step 404 the restaurant evaluation server sends to the customer a message containing a customer survey and incentive for answers. The customer survey may cover several key performance indicators of the restaurant, e.g., food, drink, service, decoration, etc. It may ask the customer's table number, or the table number might be determined by advanced positioning technology. Examples of the incentive include electronic coupons for the next visit, electronic lottery tickets, a soft drink, etc.

In step 406 the customer receives the survey message on her or his cell phone.

In step 408 the customer can decide anytime whether to answer the survey. If the customer decides to answer the survey, in step 410 on her or his cell phone the customer inputs answers to the survey questions and then submits the answers.

In step 412 the restaurant evaluation database is updated with the customer's input.

In step 422 the restaurant evaluation server sends the customer a message of appreciation and reward information. An electronic coupon may be attached to the message. In step 424 the customer receives the message on her or his cell phone.

In step 432 the restaurant evaluation server determines whether the answers just input by the customer are extraordinary or require immediate attention.

If immediate attention is needed, in step 434 the restaurant evaluation server sends the manager an alarm message summarizing the critical items in the customer's input. In step 436 the manger receives the alarm message on her cell phone.

In step 438 the manager handles the extraordinary situations if she considers necessary. Then in step 440 the manager replies to the alarm message with information about her actions and results. In step 442 the restaurant evaluation database was updated with the manager's reply.

In step 452 the restaurant evaluation server determines whether it is the end of the business day. If it is, in step 454 the server sends every employee a message reporting information relating to her or his performance during the day, plus advice, rewards, penalty, etc. In step 456 all employees receive their respective reports on their notification receiving and displaying device, e.g., cell phones.

On top of receiving messages relating to extraordinary survey inputs, through her client device the manger can also retrieve performance information and analyses of any particular employee, the store she manages, the whole store chain, etc., depending on access privilege and control.

As illustrated by this example, the evaluation method may comprise the step of providing an evaluator with request for evaluation input. Furthermore, the request for evaluation is triggered by at least one relation between the evaluator and the event and the evaluated object; the relation can be time, duration, distance, location, use, expense, etc. In this example, duration is the relation used to trigger the request for evaluation.

This example also illustrates that a notification message may contain a consolidation of the evaluation input of multiple evaluators, and a notification message may also contain a consolidation of the evaluation input relating to multiple events.

In this example, customer survey is conducted in a way that is convenient to customers and effective for the restaurant. The manager handles urgent matters in a timely manner, and customers can send out request without impatiently waiting for an attendant to pass by. The employees have a review at the end of workday as a reference for better performance the next day.

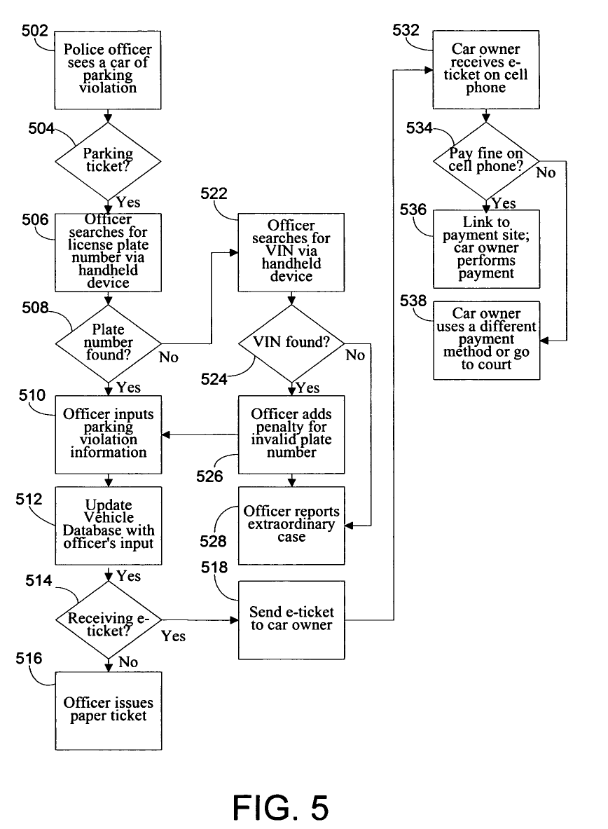

FIG. 5 illustrates an example of the steps in an embodiment of law enforcement applications. In the example the evaluator's notification needs to contain proof of authentication, and the evaluated party's response may involve payment and requires transaction security.

In step 502 a police officer sees a car of parking violation. Then in step 504 the police officer decides whether to issue a parking ticket. If the officer decides to issue the ticket, in step 506 the officer searches for the license plate number of the car on or through her or his handheld device.

Step 508 provides conditions of whether the license plate number is found.

If the license plate number is not found, in step 522 the officer searches for the vehicle identification number (VIN) of the car on or through her or his handheld device. Step 524 provides conditions of whether the VIN is found. If the VIN is not found, in step 528 the officer reports an extraordinary case. If the VIN is found, in step 526 the officer adds a citation and penalty based on the invalid license plate number, then goes to both step 528 and step 510.

In step 510 the officer inputs parking violation information by, for example, selecting city name, street name, etc. Then in step 512 the vehicle database is updated with the officer's input.

Step 514 provides conditions of whether the car owner receives electronic tickets, according to the information available through the officer's handheld device. If the car owner does not, then in step 516 the officer issues a paper ticket.

If the car owner receives electronic ticket, then in step 518 the officer sends an electronic ticket to the car owner. The electronic ticket contains a proof of authentication issued by a certification authority.

In step 532 the car owner receives the electronic ticket on her or his cell phone. In step 534 the car owner decides whether to pay the fine using the cell phone. If the car owner does, then in step 536 she or he use her or his cell phone to link to the designated secure mobile payment site and perform the payment. If the car owner does not perform payment on her or his cell phone, in step 538 she or he can use a different payment method or go to the court to appeal the parking violation.

In this example, proof of authenticity and secure transaction are involved in evaluation notification and response. The method reduces paper use as well as administration and transaction costs.

As can be seen from the above exemplary embodiments, the methods and system facilitate notification for the inevitable evaluation existing in various relationships, and therefore facilitate timely performance improvement, reduce verbal conflicts, and/or reduce costs associated with evaluation actions.

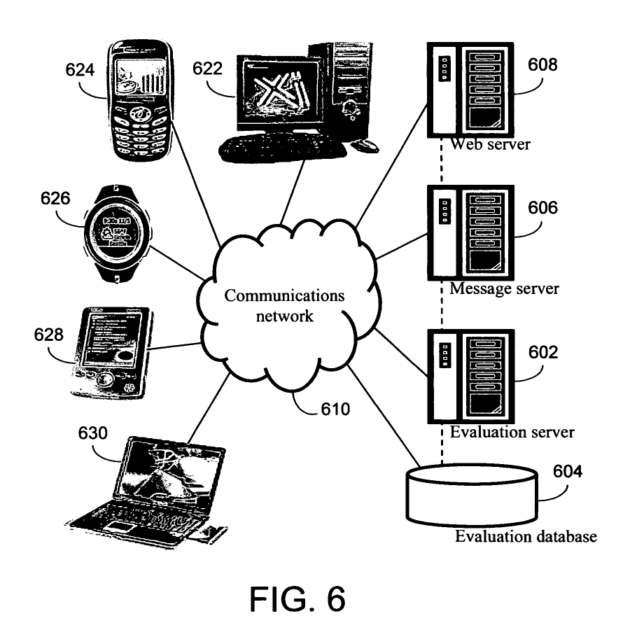

FIG. 6 illustrates elements in an evaluation system which provides notification means or options.

Evaluation server 602 comprises at least one processing unit and at least one memory unit containing at least one set of evaluation criteria. It can automate and control evaluation, and it can perform analyses and reporting.

Evaluation database 604 contains information of evaluators and evaluated objects. It can reside in the evaluation server or an independent computer unit accessible by the evaluation server. It can also synchronize with data in individual evaluation input devices.

Message server 606 stores and send messages. Examples of message servers include email servers, short message centers, instant messaging servers, multimedia message server, etc.

Web server 608 provides easy user interface for the evaluators and the evaluated parties.

Firewall software (and hardware) might be added for security. Payment and other application servers might be added for additional functions.

Communications network 610 connects the servers and the database, and connect them to evaluation input devices and notification receiving and displaying devices. It comprises any of the Internet, the wireless Internet, the mobile Internet, an intranet, a wireless intranet, a mobile intranet, an extranet, a mobile extranet, a fixed-line WAN, a wireless WAN, a mobile WAN, a fixed-line LAN, a wireless LAN, a mobile WAN, a fixed-line PAN, a wireless PAN, a mobile PAN, a fixed-line communication network, a mobile communication network, a trunk radio network, a paging network, and a radio network.

Desktop computer 622, cell phone 624, watch 626, personal digital assistant (PDA) 628, and notebook computer 630 are examples of evaluation input devices and notification receiving and displaying devices. They can directly connect to communications network 610 or indirectly through other devices or through synchronization with other devices. Other examples include fixed-line phones, mobile phones, cordless phones, smart phones, Internet clients, remote controls, televisions, handheld devices, professional devices, personal accessories, radio terminals, pagers, robots, and the like.

Some aspects of the invention relate to a system of evaluation of at least one evaluated object comprising: an evaluation means for processing evaluation input and transmitting at least one notification message, wherein the evaluation means contains at least one set of evaluation criteria; an evaluation database comprising information of the at least one evaluated object, wherein the database is accessible by the evaluation means; at least one evaluation input device that receives the evaluation input and transmits the input to the evaluation means; and at least one notification receiving device that receives the at least one notification message from the evaluation means.

From the foregoing description, it should now be appreciated that the methods and system for evaluation with notification means have been disclosed. While the invention has been described with reference to specific embodiment, the description is illustrative of the invention and is not to be construed as limiting the invention. Various modification and applications may occur to those who are skilled in the art, without departing from the true sprit and scope of the invention, as described by the appended claims.

1. A method of evaluation with means for notifying at least one recipient comprising:
(a) receiving evaluation input from at least one evaluator, said evaluation input being based on the perception of at least one event relating to at least one evaluated object by the at least one evaluator;
(b) providing means for sending notification relating to said evaluation input;
(c) generating at least one notification message; and
(d) sending the at least one notification message to the at least one recipient.

2. The method of claim 1, wherein the evaluation input is received from an evaluation input device, said evaluation input device being selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

3. The method of claim 2, further comprising a step for processing the evaluation input, wherein the processing step is performed on said evaluation input device.

4. The method of claim 1, further comprising a step for processing the evaluation input based on at least one set of evaluation criteria.

5. The method of claim 4, wherein the processing step is carried out by an evaluation server means for processing the evaluation input.

6. The method of claim 1, wherein the notification message is sent to a notification receiving device, said notification receiving device being selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

7. The method of claim 1, wherein the method of evaluation is used in organization member evaluation.

8. The method of claim 1, wherein the method of evaluation is used in family member evaluation.

9. The method of claim 1, wherein the method of evaluation is used in evaluation of any of service, service provider, process, process provider, product, and product provider.

10. The method of claim 1, wherein the method of evaluation is used in law enforcement.

11. The method of claim 1, wherein the evaluation input is recorded in an evaluation database, which contains information of the at least one evaluated object.

12. The method of claim 1, wherein the at least one evaluator is selected from a group consisting of human beings, computers, machines, virtual machines, robots, sensing devices, and animals.

13. The method of claim 1, further comprising a notification deciding step, wherein the decision is selected from a group consisting of when, whom, where, and how to send the notification, and what to be included in the notification.

14. The method of claim 13, wherein the notification deciding step is carried out by the at least one evaluator.

15. The method of claim 13, wherein the notification deciding step is carried out based on at least one set of rules.

16. The method of claim 15, wherein the at least one set of rules comprises a factor that is selected from a group consisting of at least one characteristic of the evaluator, the evaluation input, result of the processing step, at least one characteristic of the evaluated object, delay, time, recipient, address, phone number, default message, and message content for the notification.

17. The method of claim 1, wherein the at least one notification message comprises a consolidation of the evaluation input from multiple evaluators.

18. The method of claim 1, wherein the at least one notification message comprises a consolidation of the evaluation input relating to multiple events.

19. The method of claim 1, wherein the sending step is carried out through a communications network, said communications network comprising any of an Internet, a wireless Internet, a mobile Internet, an intranet, a wireless intranet, a mobile intranet, an extranet, a mobile extranet, a fixed-line WAN, a wireless WAN, a mobile WAN, a fixed-line LAN, a wireless LAN, a mobile WAN, a fixed-line PAN, a wireless PAN, a mobile PAN, a fixed-line communication network, a mobile communication network, a trunk radio network, a paging network, and a radio network.

20. The method of claim 1, wherein content of the at least one notification message comprises any of a text, a voice, an image, a video, a smell, a taste, and a feel format.

21. The method of claim 1, wherein the at least one notification message contains a proof of authenticity.

22. The method of claim 1, further comprising a step of providing privilege control of evaluation.

23. The method of claim 1, further comprising a step of providing privilege control of notification.

24. The method of claim 1, further comprising a step of requesting for evaluation input from the at least one evaluator.

25. The method of claim 24, wherein the requesting step is carried out based on at least one characteristic of any of the event and the evaluated object.

26. The method of claim 25, wherein the at least one characteristic is selected from a group consisting of time, duration, distance, location, use, frequency, expense, value, and demographics.

27. The method of claim 1, further comprising a response deciding step to be carried out by the at least one recipient, for at least one decision of whether to send a response to the notification.

28. The method of claim 27, further comprising at least a second response decision, wherein the at least a second response decision is selected from a group consisting of when, whom, where, and how to send the response, and what to be included in the response.

29. The method of claim 27, wherein the response deciding step is granted by the evaluator.

30. The method of claim 27, wherein the response deciding step is granted based on at least one set of rules.

31. The method of claim 1, further comprising a step of searching and selecting the at least one evaluated object by the at least one evaluator.

32. The method of claim 31, further comprising a step of providing privilege control on the step of searching and selecting.

33. A method of evaluation with means for notifying at least one recipient comprising steps of:
(a) receiving evaluation input from at least one evaluator, said evaluation input being based on the perception of at least one event relating to at least one evaluated object by the at least one evaluator; and
(b) deciding whether to generate at least one notification message based on the evaluation input in step (a).

34. The method of claim 33, wherein the deciding step is carried out by the at least one evaluator.

35. The method of claim 33, wherein the deciding step is carried out based on at least one set of rules.

36. A system of evaluation of at least one evaluated object comprising:
(a) an evaluation means for processing evaluation input and transmitting at least one notification message, wherein the evaluation means contains at least one set of evaluation criteria;
(b) an evaluation database comprising information of the at least one evaluated object, wherein the database is accessible by the evaluation means;
(c) at least one evaluation input device that receives said evaluation input and transmits the input to the evaluation means; and
(d) at least one notification receiving device that receives the at least one notification message from said evaluation means.

37. The system of claim 36, wherein the evaluation database further comprises information of at least one evaluator.

38. The system of claim 36, further comprising a message server means for storing and transmitting messages.

39. The system of claim 36, further comprising at least one communication network connecting the at least one evaluation input device and the at least one notification receiving device to any of the evaluation means and server means, wherein the at least one communications network comprises any of an Internet, a wireless Internet, a mobile Internet, an intranet, a wireless intranet, a mobile intranet, an extranet, a mobile extranet, a fixed-line WAN, a wireless WAN, a mobile WAN, a fixed-line LAN, a wireless LAN, a mobile WAN, a fixed-line PAN, a wireless PAN, a mobile PAN, a fixed-line communication network, a mobile communication network, a trunk radio network, a paging network, and a radio network.

40. The system of claim 36, wherein the at least one evaluation input device is selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

41. The system of claim 36, wherein the at least one notification receiving device is selected from a group consisting of a computer, a fixed-line phone, a mobile phone, a cellular phone, a cordless phone, a smart phone, a personal digital assistant, an Internet client, a remote control, a television, a handheld device, a professional device, a watch, a personal accessory, a radio terminal, a pager, and a robot.

42. The system of claim 36, wherein the evaluation means is comprised in the evaluation input device.

43. The system of claim 36, further comprising at least one Web server.

44. The system of claim 36, further comprising at least one firewall.
